(19) United States
(12) Patent Application Publication
(10) Pub. No.: US 2023/0362646 A1
(43) Pub. Date: Nov. 9, 2023

(54) SYSTEMS AND METHODS FOR EXECUTING A RESET MODE FOR ARCHITECTURAL STRUCTURE COVERINGS

(71) Applicant: Hunter Douglas Inc., Pearl River, NY (US)

(72) Inventor: Wesley Felteau, Golden, CO (US)

(21) Appl. No.: 18/245,865

(22) PCT Filed: Aug. 13, 2021
(86) PCT No.: PCT/US2021/045847

§ 371 Date: Mar. 17, 2023

Related U.S. Application Data
(60) Provisional application No. 63/082,136, filed on Sep. 23, 2020.

(51) Int. Cl. H04W 12/08; H04L 12/28; H04W 12/043; E06B 9/322

(52) U.S. Cl. CPC H04W 12/08; H04L 12/282; H04W 12/043; E06B 9/322

(57) ABSTRACT

Examples of the present disclosure relate to various aspects of architectural structure coverings. A particular aspect relates executing a reset mode for one or more of architectural structure coverings. In said aspect, reset data is sent by an architectural structure covering indicating that this covering is in the reset mode. A user device receives the reset data, presents a user interface that identifies selectable reset actions. Upon a user selection of one of the reset actions, a reset instruction about the reset action is sent from the user device to the architectural structure covering that then performs the reset action.

### CROSS-REFERENCE TO RELATED APPLICATIONS

This application claims the benefit of, and priority to U.S. Provisional Application Ser. No. 63/082,136, filed Sep. 23, 2020, which is incorporated here by reference.

### BACKGROUND

Architectural structure coverings, such as blinds, shades, shutters, and drapes, provide shading and privacy. Some architectural structure coverings may be manually operable (e.g., through use of a lift chord), while other architectural structure coverings may be motorized (e.g., by an electronic motor). Motorized architectural structure coverings can be operated remotely by a user device (e.g., a remote control, mobile device, or keypad). However, in edifices that have multiple architectural structure coverings, user interaction with the remotely controlled architectural structure coverings is often challenging due to the difficulty of determining the direct control of the desired architectural structure coverings and configuring the user interface of the user device to control a desired architectural structure covering.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure relate to various aspects of architectural structure coverings. A particular aspect relates to executing a reset mode for one or more of architectural structure coverings. In an example, a user interaction with an architectural structure covering is received, such as push of a reset button on the architectural structure covering. In response, the architectural structure covering starts a timer, enters a reset mode, and sends reset data using, for instance an advertising signal that is broadcasted periodically. A user device receives the reset data and presents a user interface, such as a graphical user interface (GUI) that includes a pop-up window. The user interface provides options to reset different features different features of the architectural structure covering, such as to complete a factory reset, remove certain automation, remove scenes, transfer ownership, etc. Upon a selection of one of the option before the expiration of the timer, the user device sends a reset instruction to the architectural structure covering. In turn, the architectural structure covering receives and performs the instruction.

In a further example, the architectural structure covering stores an identifier of the architectural structure covering and a key pair. The key can be associated with multiple architectural structure coverings installed in an edifice. Absent of the reset mode, a user device can connect to or exchange data with the architectural structure covering by presenting the key (or a hash thereof) to the architectural structure covering that then compares it to the key (or hash) stored in the architectural structure covering's memory and/or that encrypts/decrypts wireless data traffic with the key (or an associated key in the case of asymmetric encryption). In the reset mode, the transfer ownership option is available such that the key can be sent to a user device that does not currently have a copy of the key. Upon receiving a reset instruction related to the transfer ownership option, the architectural structure covering responds with the key. The user device stores the key. Subsequently, the user device can re-connect with the architectural structure covering (absent the reset mode) and any other shades in the edifice that use the key.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 is a perspective view of an example architectural structure covering in an open and extended configuration.

FIG. 2 is a block diagram of an example architectural structure covering controller of the architectural structure covering shown in FIG. 1.

FIG. 3 is an example architectural structure covering system.

FIG. 4 is a schematic view of an example user interface (UI) for interacting with an example architectural structure covering system.

FIG. 5 illustrates an example computing environment in which a reset mode of an architectural structure covering may be performed.

FIG. 6 illustrates an example UI that supports a reset mode of an architectural structure covering may be performed.

FIG. 7 illustrates an example computing environment for modifying ownership and/or access to one or more architectural structure coverings.

FIG. 8 illustrates an example method for executing a reset mode for one or more of architectural structure coverings.

FIG. 9 illustrates an alternate example method for executing a reset mode for one or more of architectural structure coverings.

FIG. 10 illustrates an example method for modifying ownership and/or access to one or more architectural structure coverings.

FIG. 11 illustrates an alternate example method for modifying ownership and/or access to one or more architectural structure coverings.

FIG. 12 is a block diagram of an exemplary operating environment in which one or more of the present examples may be implemented.

### DETAILED DESCRIPTION

Architectural structure coverings are typically placed over an architectural structure, for example, but not limited to, windows, doors, doorways, etc. The coverings are remotely controlled by a user device, such as, but not limited to, a mobile computing device (e.g., smartphone or remote control), a tablet computing device, a laptop computing device, or a desktop computing device, among other electronic devices. The user device provides a user interface (UI) for receiving operational control instructions from the user (e.g., extend or retract the coverings, open or close the vanes, modify permission/ownership to the covering, etc.). The operational control instructions (or instructions/commands associated corresponding therewith) are provided to the covering. The covering then causes one or more actions to be performed based on the receive instructions. The systems and methods described herein relate to at least one such action. Specifically, the systems and methods described herein relate to executing a reset mode for one or more of architectural structure coverings. In the systems and methods, a reset instruction is received by a covering. The reset instruction is provided to a user device associated with the covering. The reset instruction causes an interface to be displayed by the user device. Upon receiving a selection of an option presented by the interface, the user device sends an indication of the selected option and a security key to the covering. Upon validating the security key, the covering performs an action corresponding to the selected option.

As will be understood from the foregoing disclosure, aspects of the present disclosure provide techniques for implementing a reset mode for one or more architectural structure coverings. In an example of such techniques, an architectural structure covering receives a user interaction to initiate the reset mode. In response, the architectural structure cover sends reset data via a broadcast to advertise that the reset mode has been entered. A user device receives the reset data and presents a user interface that includes selectable options that correspond to actions supported by the reset mode. Upon receiving a user selection of one of the options via the user interface, the user device generates and sends a reset instruction to the architectural covering. The reset instruction indicates an action that corresponds to the selected option. The architectural structure covering performs the action.

Such approach provides various benefits. For instance, it may difficult to users to remember how to reset different features of an architectural structure covering by using one or more buttons of the architectural structure covering. Instead, the resets can be performed in a user-intuitive manner via a user interface. In addition, the process by which a security key is exchanged between the architectural structure covering and the user device is improved. Because the security key is usable to establish a subsequent connection between the architectural structure covering and the user device, where this connection is usable to control operations of the architectural structure covering, the overall control process is also improved.

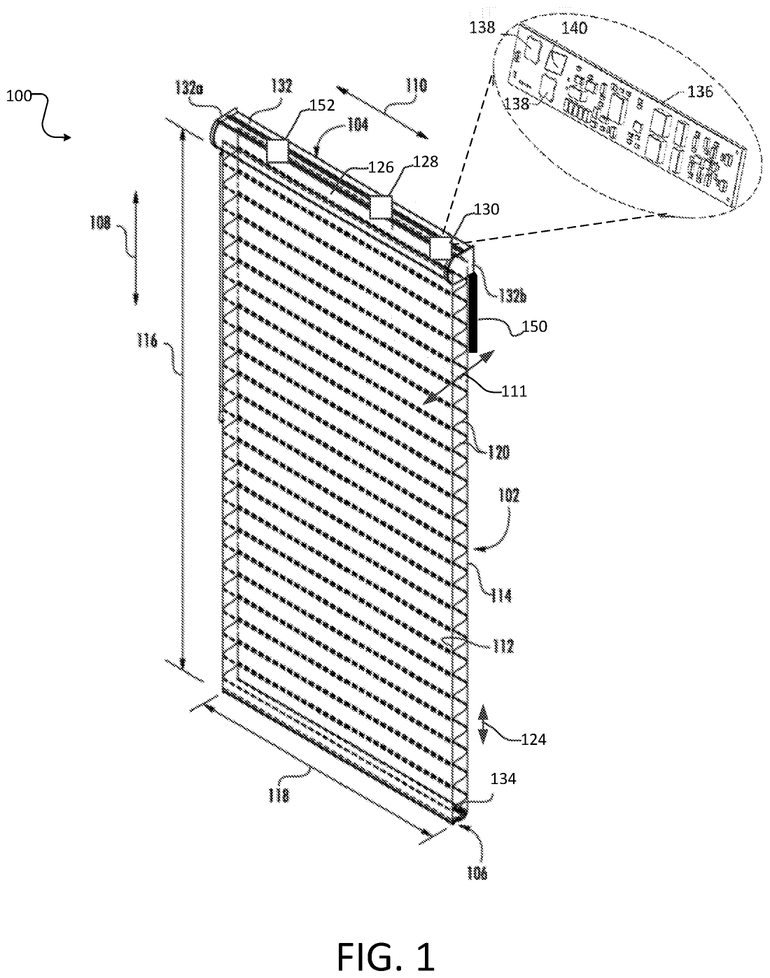

FIG. 1 is a perspective view of an exemplary architectural structure covering 100 in an open and extended configuration. The architectural structure covering 100 includes a shade panel 102 configured to extend vertically between a roller assembly 104 and a bottom rail assembly 106. The shade panel 102 is generally configured to be moved vertically 108 relative to the roller assembly 104 between a fully lowered or extended position (e.g., as illustrated in FIG. 1) and a fully raised or retracted position (not shown). When the architectural structure covering 100 is in its retracted position, the shade panel 102 may be configured to expose an adjacent architectural structure (e.g., a window), and when the covering 100 is in its extended position, the shade panel 102 may be configured to cover the adjacent architectural structure. Additionally, the covering 100 is configured to move the shade panel 102 to any number of intermediate positions defined between the fully retracted and fully extended positions so that the shade panel 102 partially covers the adjacent architectural structure.

In the example, it should be appreciated that, as used herein, the term “vertical” generally describes the orientation or arrangement of the architectural structure covering 100 in its extended position as indicated by arrow 108, such as when the covering 100 is mounted for use relative to an adjacent architectural structure. As such, movement in a vertical direction describes movement of the bottom rail assembly 106 toward or away from head rail 132, as indicated by arrow 108. Similarly, the term “horizontal” generally describes a direction perpendicular to vertical 108 that extends side-to-side relative to the covering 100, as illustrated by arrow 110. Further, the term “cross-wise” generally describes a direction perpendicular to both vertical 108 and horizontal 110 and extends front-to-back relative to the covering 100, as illustrated by arrow 111. The various directional references used herein are simply utilized to provide context to the examples shown, and thus, should not be construed as otherwise limiting. For instance, some architectural structure coverings 100 may have its shade panel 102 configured to extend and retract in the horizontal direction.

In some examples, the shade panel 102 includes both a front panel 112 and a back panel 114, with the front and back panels 112, 114 being configured to be arranged generally parallel to each other in the vertical direction 108 and when the shade panel 102 is moved to its fully extended position (shown in FIG. 1). In general, the panels 112, 114 are formed from any material suitable for use within the disclosed covering 100, such as a textile, a woven and/or non-woven fabric, and/or the like. However, in some examples, one or both of the panels 112, 114 are formed from a sheer fabric or other suitable material(s) that allows at least a portion of the light hitting the shade panel 102 to pass from one panel to the other. Additionally, it should be appreciated that the front and back panels 112, 114 may generally be sized, as required or desired, to use relative to any suitable architectural structure. For example, the panels 112, 114 define a vertical height 116 and/or a horizontal width 118 sufficient to cover a window or other architectural structure. In one example, the front and back panels 112, 114 define substantially the same height 116 and/or width 118 such that the panels 112, 114 are substantially coextensive when the shade panel 102 is in its fully extended position.

The shade panel 102 also includes a plurality of light blocking members or vanes 120 that extend between the front and back panels 112, 114, with the vanes 120 being spaced apart vertically from one another along the vertical height 116 of the shade panel 102. In some examples, each vane 120 is configured to extend the full depth or cross-wise direction 111 between the front and back panels 112, 114. For example, each vane 120 includes a front edge coupled to the front panel 112 and a back edge coupled to the back panel 114 using any suitable means, such as stitching, sticking, adhesives, mechanical fasteners, and/or the like. Additionally, similar to the panels 112, 114, the vanes 120 are formed from any material suitable for use within the disclosed covering 100, such as a textile, a woven and/or non-woven fabric, and/or the like. However, in some examples, the vanes 120 are formed from a material used to form the front and back panels 112, 114. For example, each vane 120 is formed from a light blocking or opaque material or a translucent material.

In operation, when the shade panel 102 is positioned in its fully extended position (shown in FIG. 1), the relative positioning of the front and back panels 112, 114 may be adjusted such that the vanes 120 are tilted to control the amount of light passing through the shade panel 102 as required or desired. In some examples, the shade panel 102 is configured such that, when the front and back panels 112, 114 are moved vertically 108 relative to each other (e.g., when the back panel 114 is raised and the front panel 112 is simultaneously lowered or when the back panel 114 is lowered and the front panel 112 is simultaneously raised), the orientation or tilt angle of the vanes 120 defined between the front and back panels is adjusted. For example and as illustrated in FIG. 1, the vanes 120 are tilted to a substantially horizontal position between the panels 112, 114 such that a vertical light gap 124 is defined between each adjacent pair of vanes 120 and the vanes 120 are in a fully opened configuration. In this opened position, light passes directly through the light gaps 124 defined between the vanes 120. Alternatively, the vanes 120 may be tilted to an at least partially overlapping, substantially vertical position between the panels 112, 114 such that the vanes 120 are in a fully closed configuration (not shown). In this closed position, the overlapping vanes 120 serve to prevent all or a portion of the light hitting the shade panel 102 from passing through the shade panel 102.

Additionally, the vanes 120 may be tilted to any number of intermediate tilt positions defined between the fully open and fully closed positions. The orientation of the vanes 120 between and including the fully open and fully closed configurations, can also be referred to as view through position. It should be appreciated that in one example, the vanes 120 are spaced apart from one another and/or dimensioned such that, when moved to the fully opened position, the vanes 120 are oriented substantially horizontally 110 between the vertically hanging panels 112, 114, and when moved to the fully closed position, the shade panel 102 has a collapsed configuration in which both the vanes 120 and the panels 112, 114 hang in a substantially vertical 108 orientation.

The roller assembly 104 of the architectural structure covering 100 includes an operating mechanism 126 configured to support the shade panel 102 and control the extension and retraction of the shade panel 102 between its fully extended and fully retracted positions. In addition, operating mechanism 126 controls the tilt of the vanes 120 between their fully opened and fully closed positions. In some examples, the operating mechanism 126 is covered by a valance or other suitable covering. For instance and as illustrated in FIG. 1, the roller assembly 104 includes a head rail or cover 132 and corresponding endcaps 132a, 132b configured to at least partially encase the operating mechanism 126. Moreover, various other components of the roller assembly 104 may also be configured to be housed within the head rail 132 as required or desired. In the example, the operating mechanism 126 includes a single assembly (e.g., a motor 128 and a controller 130) that drives the extension and retraction movements of the shade panel 102 and the opening and closing movements of the vanes 120. In other examples, the operating mechanism 126 may have separate assemblies to drive the extension and retraction movements and the opening and closing movements, respectively.

It should be appreciated that one example of an architectural structure covering 100 is illustrated and described in FIG. 1. The architectural structure covering 100, however, may be any type of covering that at least partially covers an architectural element such as a window, a door, an opening, a wall, etc. In one example, the architectural structure covering 100 can be a shear-type covering. In an aspect, the shade panel has sheer front and back panels that extend and retract, and a plurality of light blocking vanes extending between the panels that tilt to open and close the covering. In another aspect, the shade panel has a single sheer panel that extends and retracts, and a plurality of light blocking vanes attached to the sheer panel that open and close by sliding one end of the vane relative to the panel. In yet another aspect, the shade panel has a single sheer panel that extends and retracts, and a plurality of light blocking vanes that extend substantially vertically that rotate to open and close.

In another example, the architectural structure covering 100 can be a cellular-type covering. In an aspect, the shade panel has a front and back panel that are connected to each other in a cellular pattern (e.g., a honeycomb-type pattern, a roman-type pattern, etc.) and that extend and retract in an accordion-type motion. This type of cellular pattern creates a layer of insulation (e.g., air) within the covering.

In yet another example, the architectural structure covering 100 can be a roman-type covering. In an aspect, the shade panel has a single panel with a plurality of fabric folds that extends and retracts via a rolling motion (e.g., rolling the folds) or a stacking motion (e.g., stacking the folds). In another aspect, the shade panel has a front and back panel connected in a cellular pattern as described above and that extends and retracts. These panels include excess fabric to generate the roman-type folds when the covering is retracted, and are not necessarily configured to move in an open and close direction.

In still another example, the architectural structure covering 100 can be a roller-type covering. In an aspect, the shade panel has a front and back panel connected in a cellular pattern as described above, but extend and retract via a rolling motion. In another aspect, the shade panel has a single panel that extends and retracts in a rolling motion. This type of single panel can be fully or partially light blocking as required or desired, and are not necessarily configured to move in an open and closed direction. In other examples, the single panel can be a UV-blocking shade. In yet another aspect, the shade panel has a front and back panel that each have alternating sheer and light blocking bands. In this example, the shade panel is extended and retracted by a rolling motion, and also open and closed by moving the panels relative to one another.

Additionally or alternatively, the architectural structure covering 100 can be a shutter-type covering. In an aspect, the shade panel has a plurality of light blocking vanes that tilt to open and close the covering, and are not necessarily configured to move in an extended and retracted direction. The architectural structure covering 100 can be a slat-type covering. In an aspect, the shade panel has a plurality of light blocking vanes (e.g., slats) that move relative to each other to extend and retract the covering, and tilt to open and close the covering. The architectural structure covering 100 can also be a vertical-type covering. In an aspect, the shade panel has a plurality of light blocking vanes (e.g., panels or louvers) that move relative to each other in a horizontal direction to extend and retract the covering, and rotate to open and close the covering. Generally, the architectural structure covering 100 can be any type of covering that is enabled to extend and retract and/or open and close as described herein.

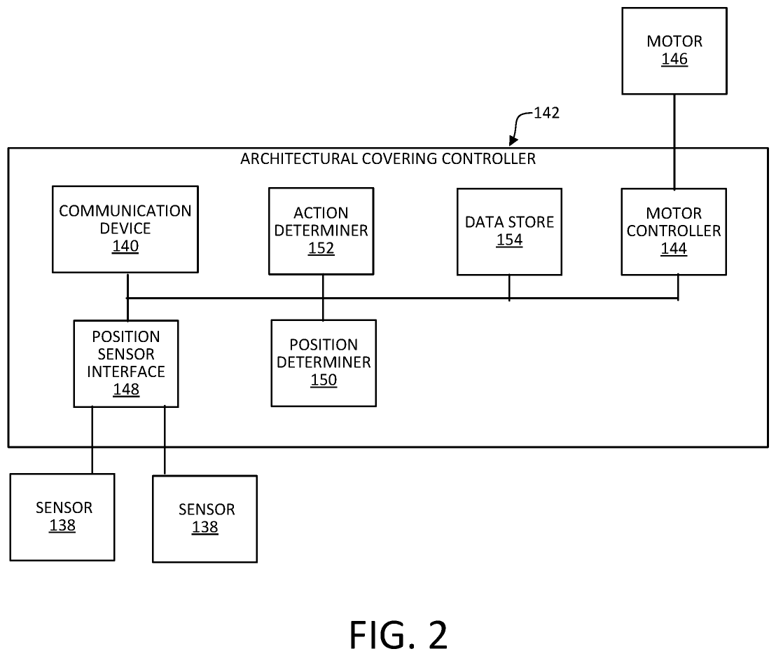

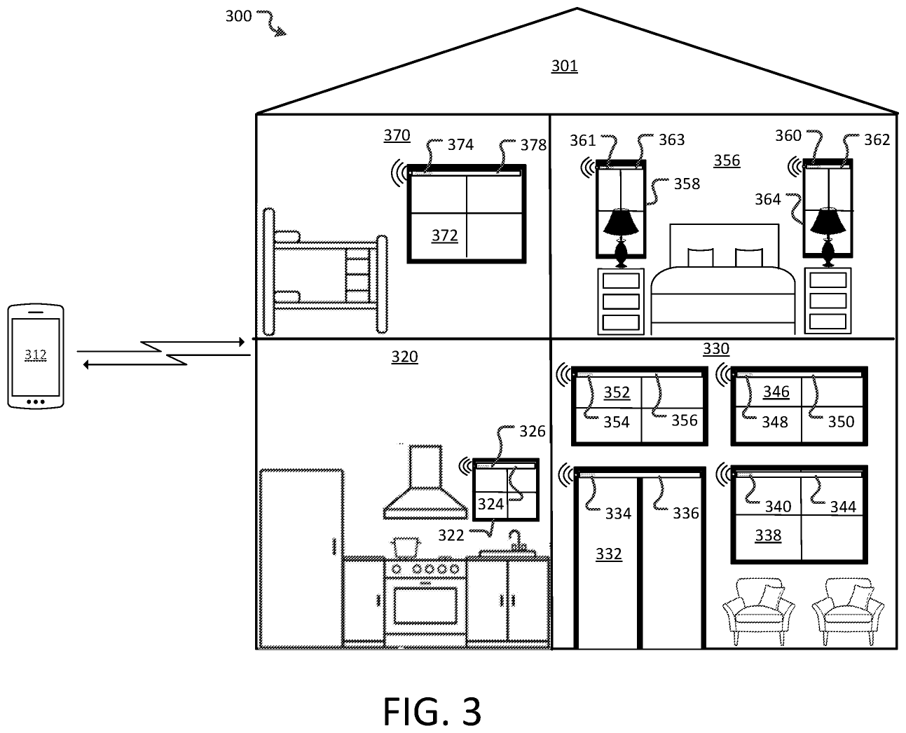

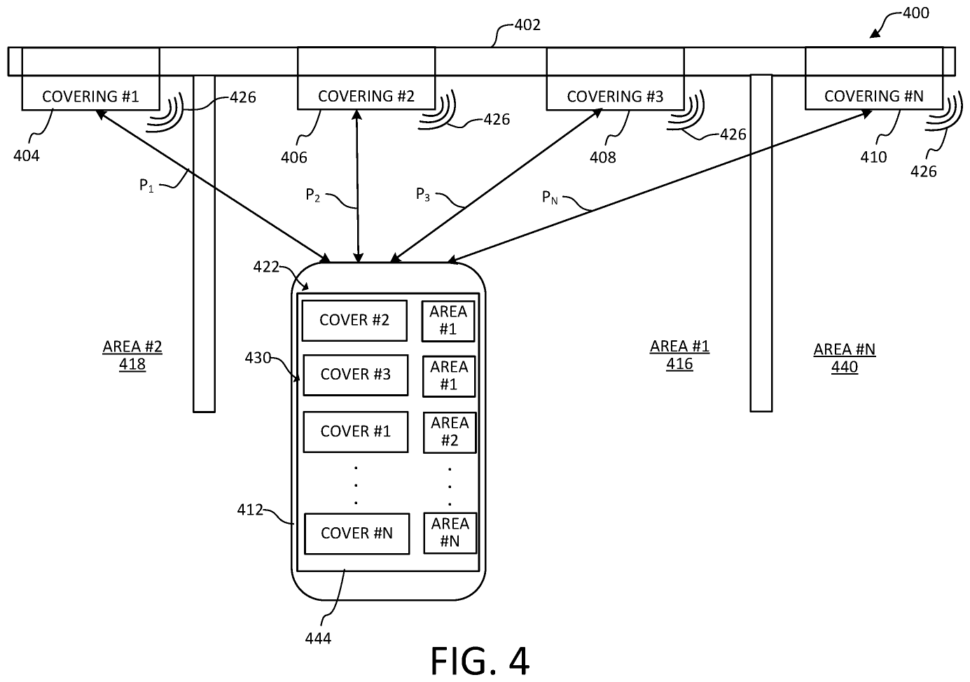

In the example, the operating mechanism 126 is electronic and motorized so that the architectural structure covering 100 is remotely operable as required or desired. The controller 130 of the operating mechanism 126 includes one or more printed circuit boards 136 for operably controlling movement of the shade panel 102 via the motor 128. The circuit board 136 electronically communicates via wired or wireless communication with the motor 128 that drives movement of the shade panel 102 and includes the electrical components (e.g., an architectural structure covering controller such as architectural structure covering controller 142 of FIG. 2) for operating architectural structure covering 100. The circuit board 136 and/or motor 128 may be powered by a combination of internal and/or external power line connections, battery(ies), fuel cells, solar panels, wind powered generator, and/or any other power source as required or desired. The circuit board 136 includes one or more sensors 138 so as to determine a position of the operating mechanism 126 and thus, a position of the shade panel 102 (e.g., an extended/retracted and/or open/close position) and shade 150. Additionally, the circuit board 136 includes a communication device 140 such as a transmitter, a receiver, a transceiver, and/or other interface to facilitate exchange of data with remote devices (e.g., user device 212 of FIGS. 3 and 4).

In operation, the architectural structure covering 100 receives operational instructions from a remote device and process and respond to the received instructions accordingly. For example, user devices may control movement of the operating mechanism 126 so as to extend or retract and/or open or close the shade panel 102 and control movement of the lift assembly 152 so as to extend or retract the shade panel 152 as required or desired. Furthermore, the architectural structure covering 100 generates a broadcast signal for receipt by the user device so that the user device can determine the type, proximity, identification, and position(s), among other things, of the covering 100 as described further herein.

FIG. 2 is a block diagram of an exemplary architectural structure covering controller 142 of the architectural structure covering 100 (shown in FIG. 1). In the example described below, the architectural structure covering controller 142 is described in connection with the operating mechanism 126 (shown in FIG. 1), however, it is understood that the controller 142 may likewise be used to control any other component of the architectural structure covering 100 as required or desired. In some aspects, the architectural structure covering controller 142 is implemented on the circuit board 136 (shown in FIG. 1).

In the example, the architectural structure covering controller 142 includes a motor controller 144 that controls one or more motors 128 of the assembly based on one or more commands. For example, the motor controller 144 controls the direction of rotation of an output shaft of the motor 128, the speed of the output shaft, and/or other operations of the motor so as to extend and retract and/or open and close the shade panel 102 (shown in FIG. 1).

The architectural structure covering controller 142 also includes a position sensor interface 148 that receives signals from the position sensors 138. The position sensor 138 may include, for example, a magnetic encoder, a rotary encoder, a gravitational sensor, etc. The position sensor 138 may be used to count pulses or rotations of the motor 128, to track the position of a rotating element (e.g., the output shaft, the roller assembly 104 (shown in FIG. 1), etc.) while movement of the covering is being driven (e.g., by a rotating member or any other driving member). The position sensor interface 148 processes the signals from the position sensor 138 and a position determiner 150 determines a position of the architectural structure covering 100 (shown in FIG. 1) based on the processed signal(s) from the position sensor interface 148.

An action determiner 152 is used to determine what action (if any) is to be performed by the motor 128 based on input information from the communication device 140 (e.g., receiving operational instructions from a remote device) and/or the position determiner 150. For example, if an operational signal is received by the communication device 140 to open the covering, the action determiner 152 sends a signal to the motor controller 144 to activate the motor 146 in an open direction. Similarly, if an operational signal is received by the communication device 140 to close the covering, the action determiner 152 sends a signal to the motor controller 144 to activate the motor 146 in a closed direction.

In some examples, an upper limit position and/or a lower limit position is used to prevent the motor 146 from moving the covering beyond a set position in either direction (e.g., open and closed). For example, if the position determiner 150 determines that the covering has reached an upper limit position (e.g., a position at or near fully opened), the action determiner 152 commands the motor controller 144 to cease activation of the motor 146. This prevents the covering from being moved too far in a manner that may otherwise cause undesirable wear on the motor 146 and/or the covering itself. Similarly, a lower limit position is used to prevent the motor 146 from closing the covering too far in the opposite direction. In another example operation, the architectural structure covering controller 142 controls the motor 146 to move the architectural structure covering to a predetermined position (e.g., a stored or favorite position). For example, the predetermined position may be a midpoint location between the upper limit position and the lower limit position. Based on the received operational control signal, the action determiner 152 and the position determiner 150 selectively uses the motor controller 144 to command the motor 146 in one direction or another so that the covering is moved to the predetermined positon.

The upper limit position, lower limit positon, and/or predetermined position(s) can be stored in a data store 154 (e.g., memory) of the architectural structure covering controller 142. In some examples, the positions are reprogrammed by a user as required or desired. The data store 154 also includes information that is emitted in a broadcast signal emitted by the architectural structure covering 100 (e.g., by the architectural structure covering controller 142), such as, covering informational data, MAC address, home identification number, covering identification number, and/or power transmission data, as described further below in reference to FIG. 3.

FIG. 3 illustrates an exemplary architectural structure covering system 300. In the example, the system 300 includes an edifice 301 separated into four architectural areas 320, 330, 356, 370, each containing one or more windows or doors with one or more architectural structure coverings on each. For example, a first architectural area 320 includes a window 322 with a first covering 324; a second architectural area 330 includes a door 332 with second covering 336, a window 338 with third covering 344, a window 346 with fourth covering 350, and a window 352 with fifth covering 356; a third architectural area 356 includes a window 358 with sixth covering 363 and a window 364 with seventh covering 362, and an n^{th} architectural area 370 includes the window 372 with n^{th} covering 378. It should be appreciated that while only eight coverings are illustrated and described, the edifice 301 may have any number of coverings as required or desired.

A user device 312 is coupled in communication with each of the architectural structure coverings 324, 336, 344, 350, 356, 362, 363, and 378 and is used to provide operational instructions thereto. The coverings 324, 336, 344, 350, 356, 362, 363, and 378 receive instructions from the user device 312 and process and respond to the received instructions accordingly. For example, instructions may include to extend or retract and/or open or close the covering. In an example, the user device 312 are a mobile computing device, a tablet computing device, a laptop computing device, or a desktop computing device, among other electronic devices including remote control devices. The user device 312 and the coverings 324, 336, 344, 350, 356, 362, 363, and 378 communicate using any of a variety of mechanisms, including, but not limited to, infrared or other optical communication, radio or wireless communication (e.g., Wi-Fi, Bluetooth, Bluetooth Low Energy, etc.), or wired communication.

The architectural areas 320, 330, 356, 370 are rooms (e.g., bedroom(s), kitchen, dining room, etc.), offices, or any other division or selection of an edifice 402 as required or desired. Because the coverings 324, 336, 344, 350, 356, 362, 363, and 378 are remotely operable via the user device 312, a user operate a specific covering given a specific area.

Each of the architectural structure coverings 324, 336, 344, 350, 356, 362, 363, and 378 is configured to generate a broadcast signal 326, 334, 340, 348, 354, 360, 361, and 371 that is received by the user device 312 as will be explained in more detail in FIG. 4. A broadcast signal sent from an architectural structure covering indicates at least an identifier of the architectural structure covering. In an example, a broadcast signal sent from an architectural structure covering advertises that the architectural structure covering is in a rest mode.

FIG. 4 is a schematic view of an example user interface (UI) for interacting with example architectural structure covering system 400. In the example, the system 400 includes an edifice 402 having a plurality of architectural structure coverings, for example, a first architectural structure covering 404, a second architectural structure covering 406, a third architectural structure covering 408, and an n^{th} architectural structure covering 410. It should be appreciated that while only four coverings are illustrated and described, the edifice 402 may have any number of coverings as required or desired. A user device 412 is coupled in communication with each of the architectural structure coverings 404-410 and is used to provide operational instructions thereto. The coverings 404-410 receive instructions from the user device 412 and process and respond to the received instructions accordingly. For example, extend or retract and/or open or close the covering. In an example, the user device 412 is a mobile computing device, a tablet computing device, a laptop computing device, or a desktop computing device, among other electronic devices including remote control devices. The user device 412 and the coverings 404-410 communicate using any of a variety of mechanisms, including, but not limited to, infrared or other optical communication, radio or wireless communication (e.g., Wi-Fi, Bluetooth, Bluetooth Low Energy, etc.), or wired communication.

In the example illustrated in FIG. 4, the edifice 402 is separated into three architectural areas, each containing one or more of the coverings 404-410. For example, a first architectural area 416 includes the second and third coverings 406 and 408, a second architectural area 418 includes the first covering 404, and an n^{th} architectural area 440 includes the n^{th} covering 410. The user device 412 may be mobile, and in the example, is located at least partially within the first architectural area 416. The architectural areas 416-420 are rooms (e.g., bedroom(s), kitchen, dining room, etc.), offices, or any other division or selection of an edifice 402 as required or desired.

Each of the architectural structure coverings 404-410 is configured to generate a broadcast signal 426 that is received by the user device 412. Generally, a broadcast signal represents a signal that is transmitted at a predetermined interval (or rate) independently of a request from a remote device for data that the broadcast signal can indicate and without being transmitted specifically to a particular remote device. For instance, in the context of packet-based transmissions, rather than using a unicast transmission, the broadcast signal can be broadcasted as one or more packets. A broadcast of a packet includes transmitting the packet from a single source to all possible end destination within reach of a network (e.g., a WiFi network, a Bluetooth network, a Bluetooth Low Energy network, etc.). In comparison, a unicast of a packet includes transmitting the packet from the single source to a single destination. The broadcast signal 426 can be emitted (e.g., broadcasted) at predetermined time intervals, for example, between about four and twelve emissions per second. In the example, the broadcast signal 426 includes informational data of the covering. For example, the informational data can include a name or type of the covering. In one example, the name or type of the covering can be an eight-digit code that includes a covering type (e.g., SIL for silhouette, PIR for pirouette, etc.) and the corresponding serial number or a portion thereof. Additionally or alternatively, the informational data can include a model identification number. The model identification number allows for further characteristics of the type of covering to be determined, such as, but not limited to, a horizontal covering, a vertical covering, tilt functionality, opacity control, left and right extension/retraction, etc. Generally, the informational data enables the user device 412 to determine the type and model of covering and display the information to the user on the UI.

In an example, when at least one of the architectural structure coverings 404-410 is in a reset mode, the corresponding broadcast signal 426 sent from the architecture structure covering advertises that the architecture structure covering is in the reset mode. For instance, in the context of packet-based transmissions, the broadcast signal 426 can be broadcasted as one or more packets, each of which including reset data indicating that the architecture structure covering is in the reset mode. The packets can be broadcasted at a particular rate, such as between one to twenty packets per second.

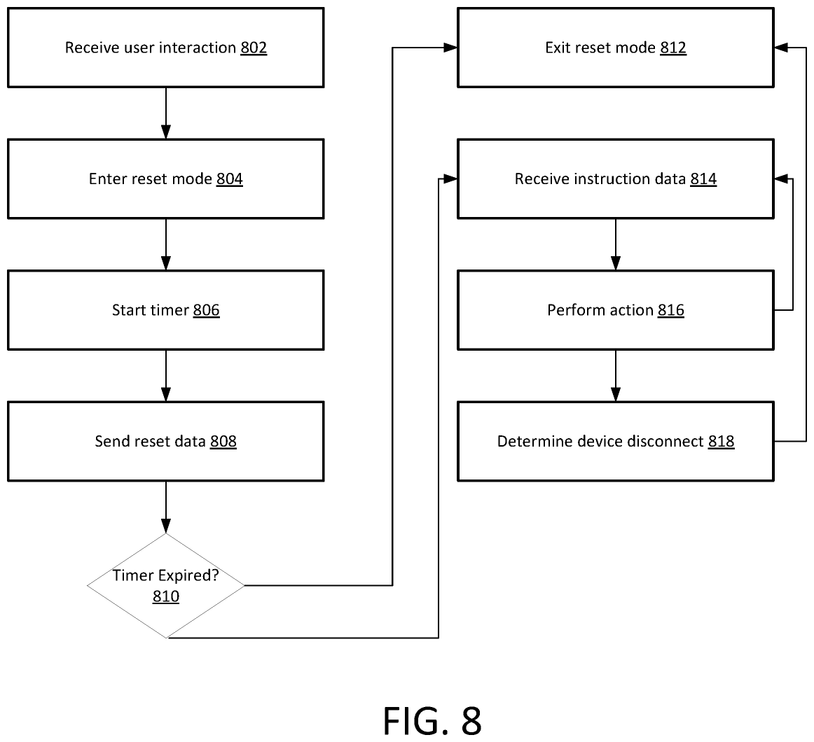

In one example, the user device 412 can locally store a database (e.g., data store or memory 804 (shown in FIG. 8)) containing types and models of a manufactures coverings, and use the informational data provided by the signal 426 to pull and display names 430 of the coverings within the UI. The user device 412 is also able to connect to a remote server (not shown) so as to receive updates to the database and/or the UI. For example, the remote server can be operated by the covering manufacture. In another example, the user device 412 can be used to push updates to the coverings 404-210 via the remote server as required or desired.

The broadcast signal 426 also includes a home identification number. The home identification number can be a unique number or hash that is associated with the architectural edifice 402 so that the coverings 404-410 can all be linked together. This restricts coverings from a neighboring architectural structure (e.g., a neighbor's house) from being included within the list 422 on the user device 412. The home identification number may also be used for security within the system 400 as required or desired. The broadcast signal 426 further includes transmit power data of the signal. For example, the first and n^{th} coverings 404, 410 are positioned more towards the exterior of the edifice 402 and as such, the emitted broadcast signal 426 may have its power increased so that the signal can be transmitted and received throughout the edifice 402. For example, the transmit power data can be 0, +4, +8, etc.

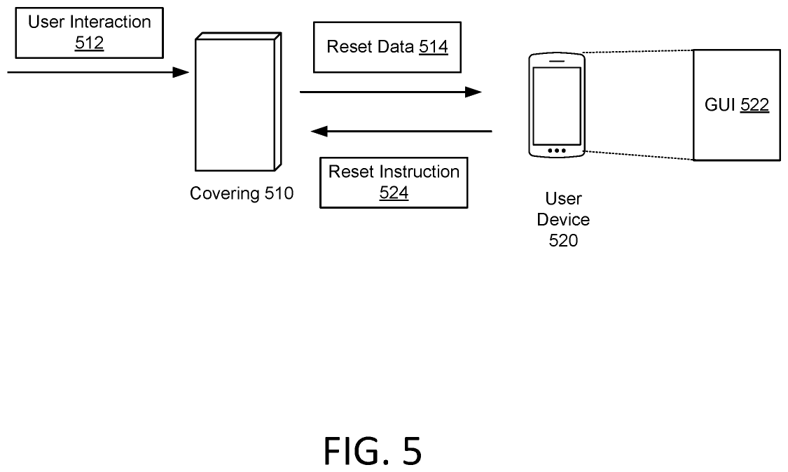

FIG. 5 illustrates an example computing environment in which a reset mode of an architectural structure covering 510 may be performed. The architectural structure covering 510 may include a button to initiate a trigger of the reset mode. Upon a user interaction 512 with the rest button, the architectural structure covering 510 (e.g., the controller 130) enters the reset mode. The user interaction 510 can be a button push, a double push, a push and hold, etc.

When in the reset mode, the architectural structure covering 510 advertises this mode. For instance, the architectural structure covering 510 sends a broadcast signal periodically. In the context of packet-based transmissions, the broadcast signal can be broadcasted as one or more packets, each of which including reset data 514 indicating that the architecture structure covering 510 is in the reset mode.

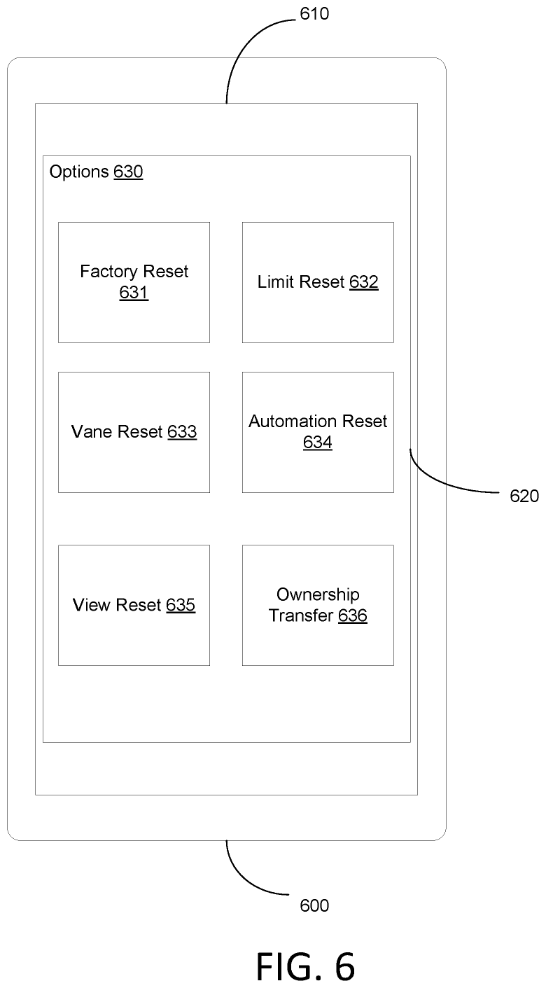

A user device 520 may receive the broadcast signal that encodes or includes reset data 514. For instance, the broadcasted packet(s) is (are) received and includes (include) the reset data 514. In an example, the user device 520 includes an application (e.g., program code) that is developed by a provider or manufacturer of the architectural structure covering 510 or a third part developer on behalf of the provider or manufacturer. The application can be downloaded from an application store and registered under a user account that is managed at a server. Upon receiving the reset data 514 and, based on an execution of the application, the user device 520 may present a graphical user interface (GUI) 522 that includes options for actions provided by the reset mode. An example of the GUI 522 is further illustrated in FIG. 6.

Upon a user selection of an option, the user device 520 generates and sends a reset instruction to the architectural structure covering 510. The reset instruction indicates an action to be performed by the architectural structure covering 510, where the action relates to a feature of the architectural structure covering 510 that is to be reset. The architectural structure covering 510 receives the reset instruction 524 and performs the action.

FIG. 6 illustrates an example UI that supports a reset mode of an architectural structure covering may be performed. Here, the UI is a GUI, although other presentation modalities are similarly possible (e.g., a voice interface can be used, whereby selectable options are played and speech input is received and processed to the selected option; or merely, speech input is received and processed via natural language understanding to determine a command for a supported reset action).

As illustrated, a user device 600 presents a GUI 610 on a display of the user device 600. Upon receiving reset data, such as the reset data 514, the user device 600 present a window 620, such as a pop-up window, in the GUI 610. The pop-window and the underlying functionalities can be supported by an application associated with an architectural structure covering and executing on the user device 600. The window 620 includes multiple selectable GUI elements (e.g. selectable icons or tiles) that identify and provide textual and/or graphical information about options 630 that can be selected to trigger actions provided by a reset mode of the architectural structure covering. The options 630 can include, for instance, a factory reset 631, a limit reset 632, a vane reset 633, an automation reset 634, a view reset 635, and ownership transfer 636, and/or any other reset actions that the reset mode supports (e.g., a transition point reset, a scene reset, etc.). The factory reset 631 changes the current configuration of the architectural structure covering to a default configuration (also known as factory configuration). The limit reset 632 can specify a length to extend/retract shade panel. The vane reset 633 can specify an amount to open/close vanes. The automation reset 634 can change an automation configuration of the architectural structure covering. The view reset 635 can change a scene(s) or a view through position configuration, such as to enable/disable a blackout shade. The transfer ownership 636 can enable/disable access to the architectural structure covering via the application by processing one or more security keys that control such access.

Upon a user selection of one of the options, the user device 600 sends a reset instruction indicating the selection. For instance, the application generates parameters that identify and control aspects of the action and the reset instruction includes these parameters.

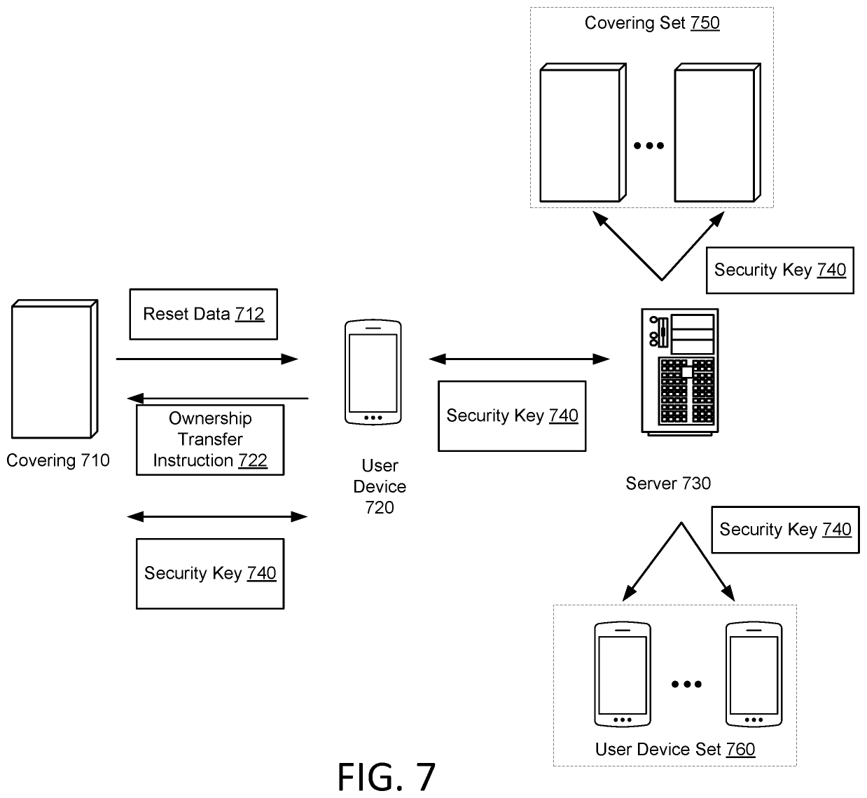

FIG. 7 illustrates an example computing environment for modifying ownership and/or access to one or more architectural structure coverings. In an example, an architectural structure covering 710 is an a reset mode and sends rest data 712 to a user device 720. The user device may be associated with a user account managed by a server 730. Prior to the initiation of the reset mode, the architectural structure covering 710 may not be registered under the user account, and may store a security key 740 that is used to establish a connection with user devices, absent the reset mode. Also prior to the initiation of the reset mode, the user device 720 may not have a copy of the security key. That may be the case when, the initiation of the reset mode, ownership of or access to the architectural structure covering 710 via the user device 720 is not tied to the user account yet. In response to the reset data 712, the user device 720 presents a user interface and a user selections is received to transfer ownership of the architectural structure covering 710 or, similarly, to provide access thereto via the user device 720, such that the architectural structure covering 710 becomes tied to the user account.

A user selection is received to transfer the ownership (or provide the access). In response, the user device 720 sends an ownership transfer instruction 722 to the architectural structure covering 710 indicating a request to perform a reset action by which the ownership is transferred (or access is provided).

Multiple options exist to do so. In a first example option, the architectural structure covering 710 sends the security key 740 to the user device 720. In turn, the user device 720 stores the key for subsequent connections with the covering architectural structure covering 710 and any other architectural structure covering(s) that use the same security key 740. For instance, a set 750 of architectural structure coverings is installed in the same edifice and store copies of the same security key 740. The user device 720 also sends the security key 740 to the server 730 that stores it under the user account. The server 730 can also send copies of the security to other user devices from a 760 associated with the user account. As such, any user device from the set 760 can subsequently connect with any of the architectural structure coverings from the set 750.

In a second example option, the user device 720 presents an option to generate a new security key (in this case, the new security key is shown as security key 740 in FIG. 7). Based on user input in response to this option, the user device 720 generates and sends the new security key 740 to the architectural structure covering 710. In addition, the ownership transfer instruction 722 indicates to the architectural structure covering 710 that any existing security key stored in a memory of the architectural structure covering 710 is to be replaced. In turn, architectural structure covering 710 replaces the existing key with the new security key 740. Further, the user device 720 sends the new security key 720 to the server 730 that stores it in association with the user account and that distributes it to the user device(s) of the set 760. The server 730 can also send the new security key 740 to remaining architectural structure covering of the set 750, or the architectural structure covering 710 can send the new security to this set 750 (e.g., when the architectural structure coverings are set-up in a mesh or star network topology).

The above two example options can be used in combination or as alternate to each other. In both examples, in addition to storing the security key 740 in the user account, other information related to the architecture covering 710, the set 750, and/or the edifice can be also stored in the user account. For instance, covering identifiers (IDs) and an edifice identifier can be store.

Furthermore, although the above example is illustrated in connection with a reset mode of a single architectural structure covering causing a distribution of a security key to multiple architectural structure covering, the embodiments of the present disclosure are not limited as such. For instance, any reset action can be triggered by a user device upon receiving reset data from an architectural structure covering that is in a reset mode. When this covering is associated with one or more other architectural structure covering(s) via a user account, rather than having to initiate the reset mode at each of the other architectural structure covering(s), the reset instruction can be automatically from the user device to a server (or a local hub) that then sends the reset instruction to the each of the other architectural structure covering(s).

FIG. 8 is a flowchart illustrating an example method for executing a reset mode for one or more of architectural structure coverings. The method may be performed by an architectural structure covering, such as the architectural structure covering 510 or 710. The method begins at operation 802, where an architectural structure covering receives a user interaction 802 with a button of the architectural structure covering. In response, the architectural structure covering enters a reset mode at operation 804.

At operation 806, the architectural structure covering starts a timer having a predefined time length (e.g., three minutes or some other duration). The timer can be started upon detecting the user interaction or upon entering the reset mode. At operation 808, the architectural structure covering sends reset data indicating that the architectural structure covering is in the reset mode. The reset data can be sent in a periodic broadcast signal that advertises the reset mode.

At operation 810, the architectural structure covering determines whether the timer has expired or not. If the timer has expired and not reset instruction has been received in response to the sending of the reset data, the architectural structure covering exits the reset mode at operation 812, where the architectural structure covering stops the broadcast of the reset data. Otherwise, operation 814 follows operation 810.

At operation 814, the architectural structure covering revives a reset instruction from a user device. For instance, the architectural structure covering and the user device establish a connection. The connection can be established without the user of a security code while the architectural structure covering is in the reset mode. The reset instruction can be received based on a user selection of a reset action to be performed by the architectural structure covering. The reset instruction can identify the reset action and include parameters controlling the execution of the reset action.

At operation 816, the architectural structure covering performs the reset action. For instance, the reset instruction executes the reset action according to the controlling parameters. A loop between operation 816 and 814 may exist such that multiple reset instructions and multiple reset actions may be performed. In addition, the user device can send the reset instruction to a server for distribution to other architectural structure architectural structure covering can send each of the reset instruction to one or more other architectural structure coverings that are associated with the architectural structure covering (e.g., that share the same edifice ID and the same security key).

At operation 818, the architectural structure covering determines a device disconnect, whereby the connection with the user device has been disconnected. For instance, the device disconnect is determined based on either a device disconnect instruction from the user device or a number of missed connection windows depending on the underlying communications protocol (e.g., WiFi, Bluetooth, Bluetooth Low Energy, etc.). Option 812 follows operation 818, where the architectural structure covering exits the reset mode.

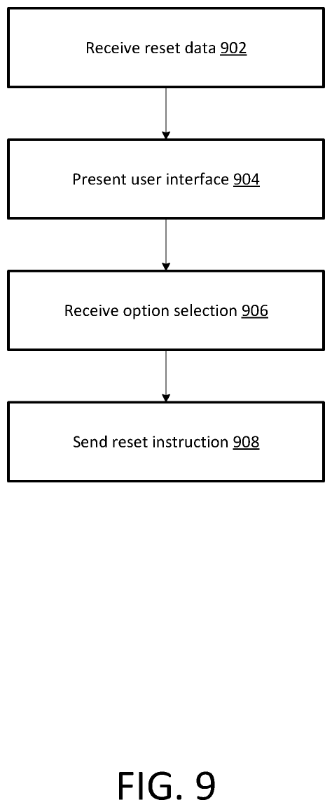

FIG. 9 is a flowchart illustrating an alternate example method for executing a reset mode for one or more of architectural structure coverings. The method is performed by a user device, such as the user device 520 or 720. The device executes an application associated with the one or more of architectural structure coverings. The method begins at operation 902, where reset data is received by the application executing on the user device. In aspects, the reset data originates from an architectural structure covering and indicates that the architectural structure covering is in a reset mode. For example, an architectural structure covering generates a broadcast signal comprising the reset data in response to an event indicating a user intent for the reset mode. The reset mode is configured to provide access to one or more architectural structure covering management options. The reset mode instruction comprises, or is accompanied by, informational data for an architectural structure covering (e.g., covering name, covering type/model, covering identifier, position identifier, etc.), structure information (e.g., structure network SSID, structure identifier, owner information, etc.), a set of executable instructions, an indication of a task or an event to be performed, and/or broadcast signal data (e.g., signal strength, estimated device proximity, etc.). The reset mode instruction is transmitted to the user device using one or more data transmission technologies (e.g., Bluetooth, Bluetooth Low Energy, Wi-Fi, cellular, etc.).

At operation 904, the user device presents a user interface that provides options to select actions provided by the reset mode. For instance, the application presents a window in the user interface, where the window shows the selectable options, similar to the window 720 of FIG. 7. Example options include, but are not limited to, factory reset options (e.g., reset options to an initial configuration), limit reset options (e.g., specify length to extend/retract shade panel), vane reset options (e.g., specify amount to open/close vanes), automation options (e.g., automate covering manipulations at specified times), ownership options (e.g., enable/disable access to coverings), view through position options (e.g., enable/disable blackout shade), transition point options (points at which a shade can change between state), or scene options (e.g., enabling/disabling/editing/removing/adding scenes).

At operation 906, the user device receives a selection of an option via the user interface. For instance, an option for one or more reset actions are selected via a click, a touch, or some other user input that the user interface supports.

At operation 908, the user device sends reset instruction. For instance, the user device establishes a connection with the architectural structure covering, where this connection is established without a use of a security key because the architectural structure covering is in the reset mode. The reset instruction is sent via the connection, identifies the one or more reset actions, and the relevant controlling parameters. In addition, the user device can send the reset instruction to a server for distribution to other architectural structure coverings that are associated with the architectural structure covering (e.g., that share the same edifice ID and the same security key).

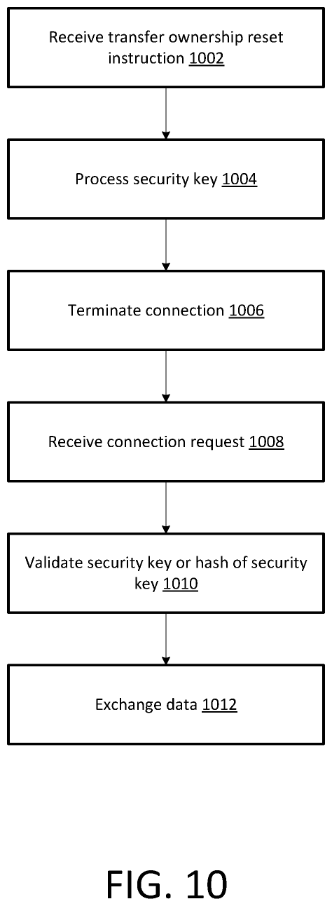

FIG. 10 is a flowchart illustrating an example method for modifying ownership and/or access to one or more architectural structure coverings. The method is performed by an architectural structure covering, such as the architectural structure covering 510 or 710. The method begins at operation 1002, where the architectural structure covering receives a transfer ownership reset instruction. This instruction is received from a user device and indicates that the ownership of the architectural structure covering is to be tied to a user account associated with the user device and/or that access to the architectural structure covering is to be tied to the user account.

At operation 1004, the architectural structure covering processes a security key based on the transfer ownership reset instruction. Processing the security can involve different operations depending on the implementation option. In one example, the processing includes retrieving an existing security key from the memory of the architectural structure covering and sending this security key to the user device. In another example, the processing includes generating a new security key based on logic stored in the memory of the architectural structure covering and executed by the controller thereof, replacing an existing key therewith, and sending the new security key to the user device. In yet another example, the processing includes requesting and receiving the key from the server or another computing resource replacing an existing key therewith, and sending the new security key to the user device. In a further example, the processing includes receiving a new security key from the user device and replacing an existing security key therewith. Examples of security keys, as used herein, include digital certificates, access tokens, authentication tokens, cookies, and the like. A security key may include various features, such as owner identification information (e.g., name, account identifier, address, etc.), public/private key, expiration date, serial number or other unique identifier, etc. In aspects, multiple architectural structure coverings can be associated with a security key. The same security key may be used for each architectural structure covering, or a different security key may be provided for one or more architectural structure covering(s). Often, the edifice is also associated with a security key (hereafter referred to as the “edifice security key”). The edifice security key corresponds the address or geospatial coordinates of the edifice. Each architectural structure covering is additionally associated with the edifice security key.

In aspects, the security key and/or the edifice security key are stored locally by the architectural structure covering(s) and/or remotely by one or more devices. For example, the user device stores a security key and the edifice security key, and/or a remote system, such as a cloud-based environment or remote server device, stores the security key and the edifice security key. When provided to the corresponding architectural structure covering(s), the security key enables a user to access/control the architectural structure covering(s). In at least one instance, in response to a request to modify the ownership of, and/or access to, an architectural structure covering, the existing security key for the architectural structure covering is deleted, revoked, or otherwise rendered inoperable. In another instance, in response to a request to modify the ownership of all architectural structure coverings in an edifice, the existing edifice security key for the edifice and the security key for each architectural structure covering in the edifice is deleted, revoked, or otherwise rendered inoperable.

At operation 1006, the architectural structure covering terminates the connection with the user device. For instance, the architectural structure covering disconnects from the user device and any new connection therewith can be possible only upon the use of the security key.

At operation 1008, the architectural structure covering receives a connection request from the user device (or, similarly, any other device), whereby the user device requests a new connection to be established with the architectural structure covering. In one example, the connection request can include the security key or a hash of the security key. In another example, no security key or hash thereof is included in the connection request.

At operation 1010, the architectural structure covering authenticates the connection request. For instance, the architectural structure covering validates the security key by comparing the received security from the connection request to the security key stored in the memory of the architectural structure covering. If a match exists, the security key is validated. Additionally or alternatively, the architectural structure covering validates the hash security key by generating a hash from the security key stored in the memory of the architectural structure covering and comparing this hash with the received hash from the connection request to. If a match exists, the hash is validated. Operation 1010 may be performed in case the security key or the hash is included in the connection request. Otherwise, operation 1010 can be skipped.

At operation 1012, the architectural structure covering exchanges data with the user device. For example, in the case when the authentication is performed, the architectural structure covering establishes the connection with the user device only when the authentication is successful (e.g., the security key or the hash thereof is validated). Once the connection is established, control instructions can be received from the user device and performed by the architectural structure covering. In another example, the authentication is not performed (e.g., operation 1010 is skipped and the connection request does not include the security key or the hash). Instead, the architectural structure covering receives an encrypted message from the user device, where the encrypted message includes data about an instruction (e.g., a control command for a motion). The architectural structure covering decrypts the encrypted message and validates the header in the message. If the message decryption and the header validation are successful, the instruction is performed. Otherwise, the architectural structure covering disconnects from the user device.

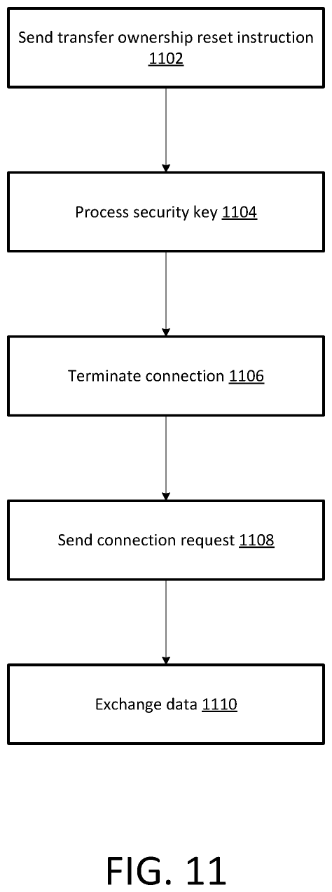

FIG. 11 illustrates an alternate example method for modifying ownership and/or access to one or more architectural structure coverings. The method is performed by a user device, such as the user device 520 or 720. The method begins at operation 1102, where user device sends a transfer ownership reset instruction. This instruction is sent to an architectural structure covering and indicates that the ownership of the architectural structure covering is to be tied to a user account associated with the user device and/or that access to the architectural structure covering is to be tied to the user account.

At operation 1104, the user device processes a security key based on the transfer ownership reset instruction. Processing the security can involve different operations depending on the implementation option. In one example, the processing includes receiving the security key from the architectural structure covering in response to the transfer ownership reset instruction. In another example, the processing includes generating a new security key based on logic stored in the memory of the user device and/or an application executing on the user device and associated with architectural structure coverings and sending the new security key to the architectural structure covering. In yet another example, the processing includes requesting and receiving the security key from the server or another computing resource and sending the new security key to the architectural structure covering.

At operation 1106, the user device terminates the connection with the architectural structure covering. For instance, the user device disconnects from the architectural structure covering and any new connection therewith can be possible only upon the use of the security key.

At operation 1108, the user device sends a connection request to the architectural structure covering (or, similarly, any architectural structure covering), whereby the user device requests a new connection to be established with the architectural structure covering. In one example, the connection request can include the security key or a hash of the security key. In another example, no security key or hash thereof is included in the connection request.

At operation 1112, the user device exchanges data with the architectural structure covering. In one example, the user device establishes the connection with the architectural structure covering based on the authentication of the connection request (e.g., the validation of the security key or the hash thereof by the architectural structure covering). Once the connection is established, control instructions can be received from the user device and performed by the architectural structure covering. In another example, the authentication is not performed (e.g., the connection request does not include the security key or the hash). In this example, the user device sends an encrypted message that includes data about an instruction for an action to be performed by the architectural structure covering (e.g., a control command for a motion). The user device can generate a hash from the data, include the hash in a header of the message, and encrypts the message with the security key. Upon receiving the encrypted message, the architectural structure covering decrypts the encrypted message and validates the header (e.g., by generating a hash from the decrypted data and comparing to the hash in the header). If the message decryption and the header validation are successful, the action is performed. Otherwise, the architectural structure covering disconnects from the user device.

Variations to the method of FIG. 11 are possible. For instance, rather than sending the security key (or the hash) in the connection request, the user device can receive the security key (or the hash) from the architectural structure covering in a response to the connection request. The user device can then proceed with the validation and, if successful, the connection is established.

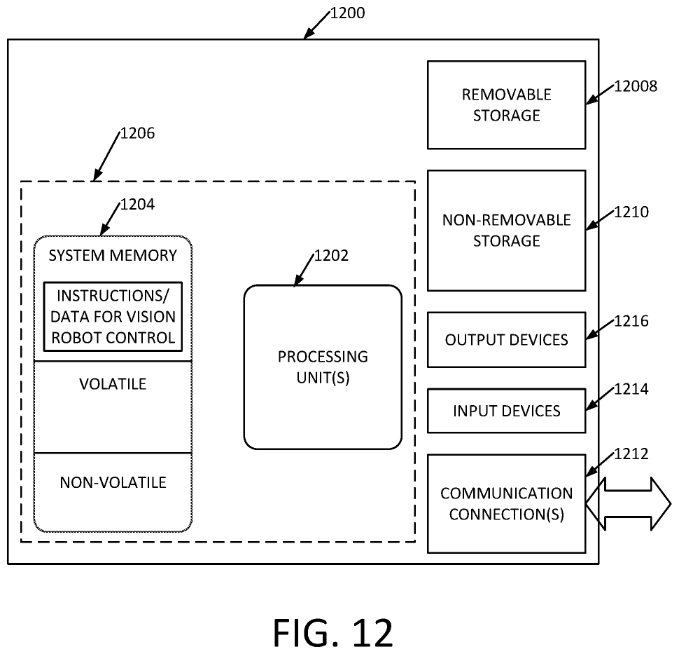

FIG. 12 is a block diagram of an exemplary operating environment 1200 in which one or more of the present examples may be implemented. For example, the architectural structure covering controller 142 (shown in FIG. 2) and/or the user devices 312, 412 (shown in FIGS. 3 and 4). This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In the most basic configuration, operating environment 1200 typically includes at least one processing unit 1202 and memory 1204. Depending on the exact configuration and type of computing device, memory 1204 (instructions to perform the computer vision robot control operations disclosed herein) may be volatile (such as RAM), non-volatile (such as ROM, flash memory, etc.), or some combination of the two. This most basic configuration is illustrated in FIG. 12 by dashed line 1206. Further, environment 1200 may also include storage devices (removable, 1208, and/or non-removable, 1210) including, but not limited to, magnetic or optical disks or tape. Similarly, environment 1200 may also have input device(s) 1214 such as keyboard, mouse, pen, voice input, etc. and/or output device(s) 1216 such as a display, speakers, printer, etc. Also included in the environment may be one or more communication connections, 1212, such as LAN, WAN, point to point, etc.

Operating environment 1200 typically includes at least some form of computer readable media. Computer readable media can be any available media that can be accessed by processing unit 1202 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer readable media.

The operating environment 1200 may be a single computer operating in a networked environment using logical connections to one or more remote computers. The remote computer may be a personal computer, a server, a router, a network PC, a peer device, or other common network node, and typically includes many or all of the elements described above as well as others not so mentioned. The logical connections may include any method supported by available communications media. Such networking environments are commonplace in offices, enterprise-wide computer networks, intranets, and the Internet.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. An architectural structure covering that comprises:
a processor; and
a memory storing computer executable instructions that, upon execution by the processor, configure the architectural structure covering to:
send reset data to a user device, the reset data causing the user device to present a user interface that corresponds to a reset mode of the architectural structure covering, the reset data sent based on a user interaction with a button of the architectural structure covering;
receive, from the user device, a reset instruction indicating one or more actions provided by the reset mode, the reset instruction received based on a selection via the user interface of the one or more actions; and
perform the one or more actions based on the reset instruction.

2. The architectural structure covering of claim 1, wherein the reset data is sent in a broadcast signal and comprises an identifier of the architectural structure covering.

3. The architectural structure covering of claim 1, wherein the user interaction comprises a push and hold of the button, wherein the execution of the computer executable instructions further configure the architectural structure covering to start a predefined timer based on the user interaction, wherein the reset instruction is received prior to an expiration of the predefined timer.

4. The architectural structure covering of claim 1, wherein the one or more actions comprise at least one of: a factory reset, a limit reset, a transition point reset, a scene reset, an automation reset, or an ownership transfer.

5. The architectural structure covering of claim 1, wherein the architectural structure covering is installed in an edifice that comprises a set of architectural structure coverings, wherein the one or more actions comprise an ownership transfer, and wherein the execution of the computer executable instructions further configure the architectural structure covering to:
send, to the user device, a security key associated with the set of architectural structure coverings;
terminate a first connection with the user device;
receive, from the user device or from another user device, a connection request after the first connection is terminated, the connection request including the security key or a hash of the security key, the user device and the other user device associated with a same user account;
validate the security key or the hash of the security key; and
establish a second connection with the user device or the other user device.

6. The architectural structure covering of claim 1, wherein the architectural structure covering is installed in an edifice that comprises a set of architectural structure coverings, wherein the one or more actions comprise an ownership transfer, and wherein the execution of the computer executable instructions further configure the architectural structure covering to:
receive, from the user device, a security key associated with the set of architectural structure coverings; and
store, in the memory, the security key.

7. The architectural structure covering of claim 6, wherein the execution of the computer executable instructions further configure the architectural structure covering to:
receive, from the user device or from another user device, a connection request that includes the security key or a hash of the security key, the user device and the other user device associated with a same user account;
validate the security key or the hash of the security key; and
establish a second connection with the user device or the other user device.

8. The architectural structure covering of claim 6, wherein the execution of the computer executable instructions further configure the architectural structure covering to:
receive, from the user device or from another user device, a message that is encrypted with the security key and that includes an instruction, the user device and the other user device associated with a same user account;
decrypt the message; and
perform an action based on the instruction.

9. A user device that comprises:
a processor; and
a memory storing computer executable instructions that, when executed by the processor, configure the user device to:
receive reset data from an architectural structure covering, the reset data corresponding to a reset mode of the architectural structure covering and received based on a user interaction with a button of the architectural structure covering;
present a user interface based on the reset data, the user interface presenting selectable options for actions provided by the reset mode; and
send, to the architectural structure covering, a reset instruction based on a selection of an option for one or more actions provided by the preset mode, the reset instruction indicating the one or more actions.

10. The user device of claim 9, wherein the reset data is received in a broadcast signal and comprises an identifier of the architectural structure covering.

11. The user device of claim 9, wherein the user interaction comprises a push and hold of the button, and wherein the reset instruction is sent prior to an expiration of a predefined timer that is started based on the user interaction.

12. The user device of claim 9, wherein the user device is associated with a user account, and wherein the one or more actions comprise an ownership transfer, wherein the reset instruction indicates that the architectural structure covering is to replace a security key with a new security key, the new security key usable to connect the architectural structure covering with one or more user devices associated with the user account.

13. The user device of claim 9, wherein the architectural structure covering is installed in an edifice that comprises a set of architectural structure coverings, wherein the one or more actions comprise an ownership transfer, and wherein the execution of the computer executable instructions further configure the user device to:
receive, from the architectural structure covering, a security key associated with the set of architectural structure coverings;
terminate a first connection with the architectural structure covering; and
perform at least one of:
(i) send, to the architectural structure covering, a connection request after the first connection is terminated, the connection request including the security key or a hash of the security key, and establish a second connection with the architectural structure covering based on a validation of the security key or the hash by the architectural structure covering; or
(ii) encrypt a message with the security key, the message including an instruction for an action to be performed by the architectural structure covering, and send the message to the architectural structure covering.

14. The user device of claim 13, wherein the execution of the computer executable instructions further configure the user device to:
send the security key to at least one of: a server that manages a user account or another user device, the user device and the other user device associated with the user account.

15. The user device of claim 13, wherein the execution of the computer executable instructions further configure the user device to:
send, to another architectural structure covering of the set of architectural structure coverings, another connection request after the first connection is terminated, the other connection request including the security key or the hash of the security key; and
establish a third connection with the other architectural structure covering based on a validation of the security key or the hash by the other architectural structure covering.

16. The user device of claim 9, wherein the architectural structure covering is installed in an edifice that comprises a set of architectural structure coverings, wherein the one or more actions comprise an ownership transfer, and wherein the execution of the computer executable instructions further configure the user device to:
send, to the architectural structure covering, a security key, wherein the security key is generated by the user device or is received from a server that manages a user account associated with the user device, and wherein the security key is associated with the set of architectural structure coverings.

17. The user device of claim 16, wherein the one or more actions comprise an ownership transfer, and wherein the execution of the computer executable instructions further configure the user device to:
terminate, after the security key is sent, a first connection with the architectural structure covering;
send, to the architectural structure covering or to another architectural structure covering of the set, a connection request after the first connection is terminated; and
establish a second connection with the architectural structure covering or the other architectural structure covering based on a validation of the security key or a hash of the security key.

18. The user device of claim 17, wherein the security key is sent from the server to the other architectural structure covering.

19. A non-transitory computer-readable storage medium storing instructions that, upon execution on an architectural structure covering, cause the architectural structure covering to perform operations comprising:
sending reset data to a user device, the reset data causing the user device to present a user interface that corresponds to a reset mode of the architectural structure covering, the reset data sent based on a user interaction with a button of the architectural structure covering;
receiving, from the user device, a reset instruction indicating one or more actions provided by the reset mode, the reset instruction received based on a selection via the user interface of the one or more actions; and
performing the one or more actions based on the reset instruction.

20. The non-transitory computer-readable storage medium of claim 19, wherein the reset data is sent in a broadcast signal and comprises an identifier of the architectural structure covering, wherein the user interaction comprises a push and hold of the button, wherein the operations further comprise starting a predefined timer based on the user interaction, and wherein the reset instruction is received prior to an expiration of the predefined timer.
